(19) United States
(12) Patent Application Publication
(10) Pub. No.: US 2016/0116650 A1
(43) Pub. Date: Apr. 28, 2016

(54) COLOR FILTER SUBSTRATE AND ITS MANUFACTURING METHOD, DISPLAY PANEL AND ITS MANUFACTURING METHOD, AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventors: Liangliang JIANG, Beijing (CN); Zhizhong TU, Beijing (CN); Yongjun YOON, Beijing (CN)

(73) Assignees: BOE TECHNOLOGY GROUP CO., LTD., Beijing (CN); HEFEI XINSHENG OPTOELECTRONICS TECHNOLOGY CO., LTD., Hefei (CN)

(21) Appl. No.: 14/799,072

(22) Filed: Jul. 14, 2015

(30) Foreign Application Priority Data
Oct. 22, 2014 (CN) 201410571783.9

(51) Int. Cl. G02B 5/20; G02F 1/1339; G02F 1/1335

(52) U.S. Cl. CPC G02B 5/201; G02F 1/133516; G02F 1/133512; G02B 5/208; G02F 1/1339; Y10S 977/774; B82Y 20/00

(57) ABSTRACT

The present disclosure provides a color filter substrate and its manufacturing method, a display panel and its manufacturing method, as well as a display device. The color filter substrate includes: a main structure of the color filter substrate; and a pattern of a catalyst film layer at a region on the main structure of the color filter substrate where a sealant is located, wherein the pattern of the catalyst film layer is able to accelerate a curing speed when the sealant is irradiated by ultraviolent light.

### CROSS-REFERENCE TO RELATED APPLICATION

This application claims a priority to Chinese Patent Application No. 201410571783.9 filed on Oct. 22, 2014, the disclosure of which is incorporated in its entirety by reference herein.

### TECHNICAL FIELD

The present disclosure relates to the field of display technology, in particular to a color filter substrate and its manufacturing method, a display panel and its manufacturing method, as well as a display device.

### BACKGROUND

As compared with a cathode-ray tube (CRT) display, a liquid crystal display (LCD) has advantages, such as a thin thickness and low power consumption. As a result, the CRT display has been replaced by the liquid crystal display in many fields.

In a process of manufacturing a liquid crystal display in the related art, an array substrate and a color filter substrate are arranged opposite to form a cell. In specific, an arrangement process includes: coating, curing and rubbing an alignment film on the array substrate and the color filter substrate, then injecting liquid crystal, applying a sealant, arranging two substrates opposite to form a cell, and curing the sealant. In order to prevent the liquid crystal from diffusing to a region where the sealant is coated and consequently being in contact with the sealant resulting in contamination, the sealant is generally subjected to a pre-curing treatment by ultraviolet light prior to completely thermo-curing the sealant, so as to prevent the liquid crystal being in contact with uncured sealant, thereby to avoid the liquid crystal to be contaminated.

During the pre-curing process by the ultraviolet light , since the sealant is not colorless and transparent, an intensity of the ultraviolet light may be gradually attenuated along an irradiation direction because the ultraviolet light is absorbed by the sealant. As shown in FIG. 1, with an increasement of a depth D (corresponding to a distance from a light source) of the sealant, the curing speed is gradually decreased. Although such decreased curing speed may be compensated by enhancing intensity of the ultraviolet light or extending irradiating time, the pre-curing speed of the sealant still cannot be effectively improved.

### SUMMARY

An object of the present disclosure is to accelerate a pre-curing speed of a sealant during manufacturing a display device.

In one aspect, the present disclosure provides in embodiments a color filter substrate, including:
a main structure of the color filter substrate; and
a pattern of a catalyst film layer arranged at a region on the main structure of the color filter substrate where a sealant is located,
wherein the pattern of the catalyst film layer is able to accelerate a curing speed when the sealant is irradiated by ultraviolent light.

Alternatively, the main structure may include:
a substrate, and
a pattern of a color filter layer and a pattern of a black matrix layer both arranged on the substrate,
wherein the pattern of the catalyst film layer is arranged at a region on the pattern of the black matrix layer where the sealant is located.

Alternatively, the pattern of the catalyst film layer includes a light-conversion material capable of converting ultraviolet light to infrared light.

Alternatively, the light-conversion material is a semiconductor light-conversion material or quantum dots.

Alternatively, the semiconductor light-conversion material includes Nd³⁺ and Yb³⁺ doped lanthanum oxyhalide, and the quantum dots are CdSn or CdS.

In another aspect, the present disclosure provides in embodiments a method for manufacturing a color filter substrate, including steps of:
forming a main structure of the color filter substrate;
forming a pattern of a catalyst film layer at a region on the main structure of the color filter substrate where a sealant is located,
wherein the pattern of the catalyst film layer is able to accelerate a curing speed when the sealant is irradiated by ultraviolet light.

Alternatively, the step of forming the main structure of the color filter substrate includes: forming a pattern of a color filter layer and a pattern of a black matrix layer on the substrate; and the step of forming the pattern of the catalyst film layer at a region on the main structure of the color filter substrate where the sealant is located includes: forming the pattern of the catalyst film layer at a region on the pattern of the black matrix layer where the sealant is located.

Alternatively, the step of forming the pattern of the catalyst film layer at a region on the main structure of the color filter substrate where the sealant is located includes: depositing the catalyst film layer on the main structure of the color filter substrate; and patterning the deposited catalyst film layer to obtain the pattern of the catalyst film layer.

Alternatively, the step of forming the pattern of the catalyst film layer at a region on the main structure of the color filter substrate where the sealant is located includes: forming the pattern of the catalyst film layer with a light-conversion material capable of converting the ultraviolet light to infrared light.

Alternatively, the light-conversion material is a semiconductor light-conversion material or quantum dots.

Alternatively, the semiconductor light-conversion material includes Nd³⁺ and Yb³⁺ doped lanthanum oxyhalide, and the quantum dots are CdSn or CdS.

In yet another aspect, the present disclosure provides in embodiments a method for manufacturing a display panel, including steps of:
providing the above color filter substrate;
coating sealant on the color filter substrate;
arranging an array substrate and the color filter substrate opposite to each other to form a cell; and
irradiating the sealant by ultraviolet light in a direction from the array substrate towards the color filter substrate.

In still yet another aspect, there is provided a display panel, including the above color filter substrate.

In still yet another aspect, there is provided a display device, including the above display panel.

According to embodiments of the present disclosure, the color filter substrate includes a main structure of the color filter substrate; and a pattern of a catalyst film layer arranged at a region on the main structure of the color filter substrate where the sealant is located, wherein the pattern of the catalyst film layer is able to accelerate a curing speed when the sealant is irradiated by ultraviolent light. By using the color filter substrate according to embodiments of the present disclosure, a curing speed and uniformity of the sealant during a pre-curing process can be improved.

### BRIEF DESCRIPTION OF THE DRAWINGS

FIG. 1 is a diagram showing a changing trend of a curing ratio in accordance with different depths of a sealant;

FIG. 2 is a schematic view showing a color filter substrate according to an embodiment of the present disclosure;

FIG. 3 is a schematic view showing a display panel including the color filter substrate in FIG. 2;

FIG. 4 is a diagram showing a changing trend of a curing ratio in accordance with different depths of a sealant for the display panel in FIG. 3;

FIG. 5 is a schematic view showing a stimulated transition of a semiconductor light-conversion material; and

FIG. 6 is a flow chart showing a method for manufacturing a color filter substrate according to an embodiment of the present disclosure.

### DETAILED DESCRIPTION

The present disclosure will be further described hereinafter in conjunction with drawings and embodiments. The following embodiments are used for illustrate the present disclosure much clearer, but not intended to limit the present disclosure.

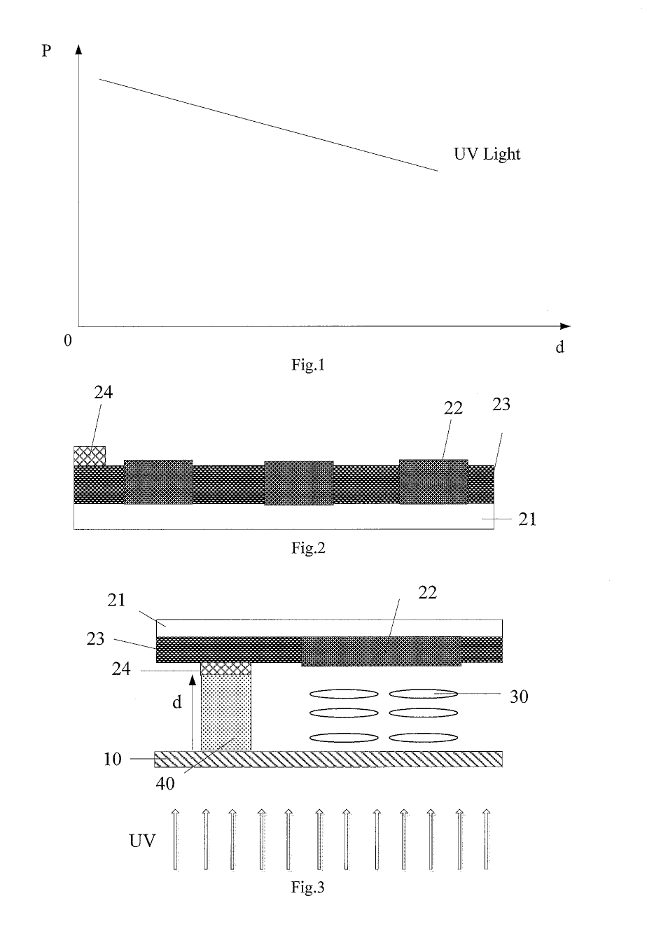

In one aspect, the present disclosure provides in embodiments a color filter substrate. As shown in FIG. 2, the color filter substrate includes: a substrate 21, a pattern of a color filter layer 22 and a pattern of a black matrix layer 23 both arranged on the substrate 21, and a pattern of a catalyst film layer 24 arranged at a region on the pattern of the black matrix layer 23 where a sealant is located. The pattern of the catalyst film layer 24 may accelerate a curing speed when the sealant is irradiated by ultraviolet light.

The substrate 21, the pattern of the color filter layer 22 and the pattern of the black matrix layer 23 constitute a main structure of the color filer substrate. Specific structure and material of each layer, and a mutual position relationship may refer to a conventional color filter substrate in the related art, which is not particularly defined herein.

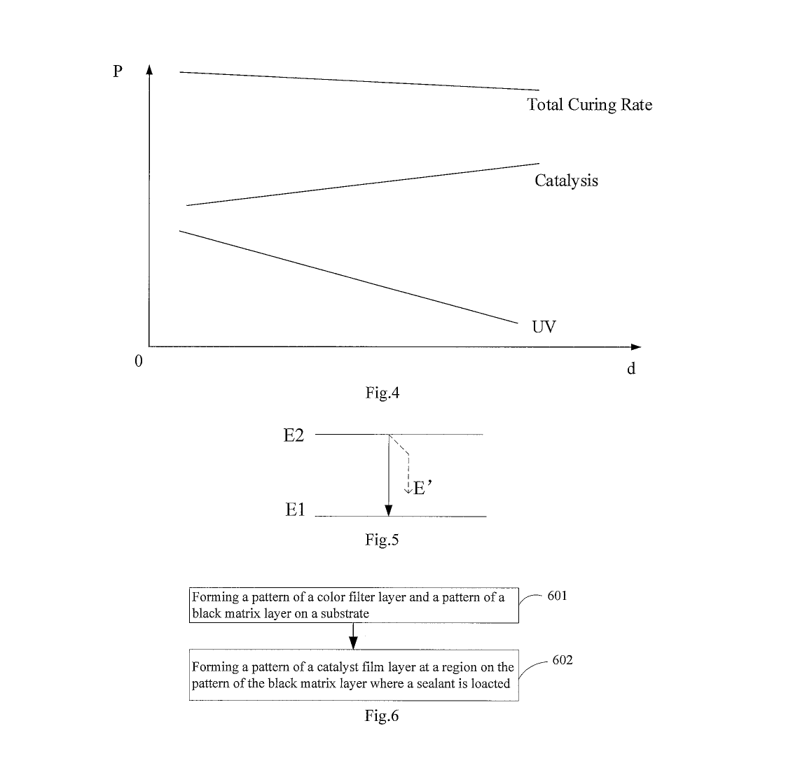

The principle for improving the curing speed and uniformity of the sealant during a pre-curing process for the color filter substrate as shown in FIG. 2 is described hereinafter in conjunction with FIGS. 3 and 4. As shown in FIG. 3, which is a schematic view of a display panel including the color filter substrate in FIG. 2, besides the color filer substrate shown in FIG. 2, the display panel further includes an array substrate 10, a liquid crystal layer 30 packed between the array substrate 10 and the color filter substrate, and a sealant 40. During the pre-curing process, the sealant 40 is irradiated in a direction from the array substrate 10 towards the color filter substrate, then a changing trend of a curing ratio in accordance with different depths of the sealant may be shown as FIG. 4, i.e., with the increasement of the depth D of the sealant, the curing speed of the sealant by the ultraviolet light is gradually decreased. However, at this time, along with the increasement of the depth D of the sealant, the sealant is getting closer to the pattern of the catalyst film layer. As a result, the curing speed may be gradually increased due to a catalytic effect by the pattern of the catalyst film layer. And finally, the curing speed everywhere becomes basically the same, so that the curing speed of the sealant far away from a light source may be guaranteed, thereby ensuring uniformity of curing.

In the color filter substrate according to embodiments of the present disclosure, since the pattern of the catalyst film layer, which is able to accelerate the curing speed when the sealant is irradiated by the ultraviolet light, is arranged on the black matrix, the curing speed of the sealant which is in contact with the pattern of the catalyst film layer may be effectively accelerated, thereby improving the curing speed and the uniformity of the sealant during the pre-curing process.

It should be appreciated that, in the above embodiment, a case that the main structure of the color filter substrate merely includes the substrate 21, the pattern of the color filter film layer 22, the pattern of the black matrix layer 23 and the pattern of the catalyst film layer 24 at the region on the pattern of the black matrix layer 23 where the sealant is located is described, which is only for illustration. In practical application, the color filter substrate herein may further include a protection layer (not shown), at this time the pattern of the catalyst film layer 24 may be arranged on the protect layer. In addition, in the practical application, the region where the sealant is located may be not provided with the pattern of the black matrix layer 23, at this time, the pattern of the catalyst film layer 24 may be directly arranged on the substrate 21. In conclusion, it is only needed to arrange the pattern of the catalyst film layer 24 at the region on a surface of the main structure of the color filter substrate where the sealant is located which specific layer the pattern of the catalyst film layer 24 is located on may not influence the implantation of the present disclosure, and corresponding technical solutions shall all be fallen within the scope of the present disclosure.

Alternatively, the pattern of the catalyst film layer 24 includes a light-conversion material which is able to convert the ultraviolet light into infrared light. In such way, the ultraviolet light may be converted into the infrared light whose energy can be absorbed by the sealant more easily, so that the ultraviolet light with less intensity may be utilized by the sealant effectively

Further, the light-conversion material may be a semiconductor light-conversion material. For the semiconductor light-conversion material, its energy level structure determines a transition level and capability. For example, a semiconductor material may be of a stimulated radiation after irradiated by the ultraviolet light with high energy. FIG. 5 is a schematic view showing an energy level transition when the semiconductor light-conversion material is stimulated. When there is a photon (e.g. a photon of the ultraviolet light) with an energy E approaching an atom being in an excited state E2, then such atom may be stimulated by this external photon and transit to a low-energy state E1, accompanied with infrared light having an energy E′ (E′<E=E′+heat energy+other energies) emitted therefrom due to a relaxation phenomenon.

In particular, the semiconductor light-conversion material may include Nd³⁺ and Yb³⁺ doped lanthanum oxyhalide. Such semiconductor light-conversion material may have a formula shown as La_{1-x-y}·Ndₓ·Yb_{y}·OX(X=F, Cl, Br).

The light-conversion material may also be quantum dots. Such quantum dots may generate light in different colors under irradiation by the ultraviolet light, such as infrared light. The quantum dots may be controlled to generate light in different colors by controlling the structure and crystal particle of the quantum dots. More specifically, the quantum dots herein may be CdSn or CdS.

The present disclosure further provides in embodiments a method for manufacturing a color filter substrate, as shown in FIG. 6, which may be used to form the color filter substrate as shown in FIG. 3. Such method includes:
Step 601: forming a pattern of a color filter layer and a pattern of a black matrix layer on a substrate;
Step 602: forming a pattern of a catalyst film layer at a region on the pattern of the black matrix layer where a sealant is located, wherein the pattern of the catalyst film layer is able to accelerate the curing speed when the sealant is irradiated by ultraviolet light.

Similarly, in the practical application, the main structure of the color filter substrate may include other structures, such as a protection layer. At this time, the pattern of the catalyst film layer should be arranged on the protection layer. As long as the pattern of the catalyst film layer is arranged at the region on the surface of the main structure of the color filter substrate where the sealant is located, then the corresponding technical solutions shall be fallen within the scope of the present disclosure.

In particular, the step 602 includes: depositing a catalyst film layer on the substrate formed with the pattern of the color filter layer and the pattern of the black matrix layer; patterning the deposited catalyst film layer to obtain the pattern of the catalyst film layer.

Processes for depositing the catalyst film layer and patterning the deposited catalyst film layer to obtain the pattern of the catalyst film layer may refer to conventional processes for manufacturing patterns of other structures in the related art, which is not described in details herein.

In specific, the above step 601 may include: forming the pattern of the catalyst film layer with a light-conversion material capable of converting the ultraviolet light into infrared light.

Alternatively, the light-conversion material is a semiconductor light-conversion material. More specifically, the semiconductor light-conversion material includes Nd³⁺ and Yb³⁺ doped lanthanum oxyhalide.

The present disclosure further provides in embodiments a method for manufacturing a display panel, including:
providing the color filter substrate according to any one of the above embodiments;
applying a sealant on the color filter substrate;
arranging an array substrate and the color filter substrate opposite to each other to form a cell; and
irradiating the sealant by ultraviolet light in a direction from the array substrate towards the color filter substrate.

The present disclosure further provides in embodiments a display panel, including the color filter according to any one of the above embodiments.

The present disclosure further provides in embodiments a display device, including the display panel.

The display device herein may be any product or component having a display function such as an electronic paper, a mobile phone, a plat computer, a television, a display, a laptop, a digital frame, and a navigator.

The above are merely the preferred embodiments of the present disclosure. It should be appreciated that, a person skilled in the art may make further modifications and improvements without departing from the principle of the present disclosure, and these modifications and improvements shall also fall within the scope of the present disclosure.

What is claimed is:

1. A color filter substrate, comprising:
a main structure of the color filter substrate; and
a pattern of a catalyst film layer arranged at a region on the main structure of the color filter substrate where a sealant is located,
wherein the pattern of the catalyst film layer is able to accelerate a curing speed when the sealant is irradiated by ultraviolent light.

2. The color filter substrate according to claim 1, wherein the main structure comprises:
a substrate, and
a pattern of a color filter layer and a pattern of a black matrix layer both arranged on the substrate,
wherein the pattern of the catalyst film layer is arranged at a region on the pattern of the black matrix layer where the sealant is located.

3. The color filter substrate according to claim 2, wherein the pattern of the catalyst film layer comprises a light-conversion material capable of converting the ultraviolet light to infrared light.

4. The color filter substrate according to claim 3, wherein the light-conversion material is a semiconductor light-conversion material or quantum dots.

5. The color filter substrate according to claim 4, wherein the semiconductor light-conversion material comprises Nd³⁺ and Yb³⁺ doped lanthanum oxyhalide, and the quantum dots are CdSn or CdS.

6. A method for manufacturing a color filter substrate, comprising steps of:
forming a main structure of the color filter substrate;
forming a pattern of a catalyst film layer at a region on the main structure of the color filter substrate where a sealant is located,
wherein the pattern of the catalyst film layer is able to accelerate a curing speed when the sealant is irradiated by ultraviolet light.

7. The method according to claim 6, wherein the step of forming the main structure of the color filter substrate comprises:
forming a pattern of a color filter layer and a pattern of a black matrix layer on the substrate; and
the step of forming the pattern of the catalyst film layer at a region on the main structure of the color filter substrate where the sealant is located comprises:
forming the pattern of the catalyst film layer at a region on the pattern of the black matrix layer where the sealant is located.

8. The method according to claim 6, wherein the step of forming the pattern of the catalyst film layer at a region on the main structure of the color filter substrate where the sealant is located comprises:
depositing the catalyst film layer on the main structure of the color filter substrate; and
patterning the deposited catalyst film layer to obtain the pattern of the catalyst film layer.

9. The method according to claim 6, wherein the step of forming the pattern of the catalyst film layer at a region on the main structure of the color filter substrate where the sealant is located comprises:
forming the pattern of the catalyst film layer with a light-conversion material capable of converting the ultraviolet light to infrared light.

10. The method according to claim 9, wherein the light-conversion material is a semiconductor light-conversion material or quantum dots.

11. The method according to claim 10, wherein the semiconductor light-conversion material comprises Nd³⁺ and Yb³⁺ doped lanthanum oxyhalide, and the quantum dots are CdSn or CdS.

12. A method for manufacturing a display panel, comprising steps of:
providing the color filter substrate according to claim 1;
coating a sealant on the color filter substrate;
arranging an array substrate and the color filter substrate opposite to each other to form a cell; and
irradiating the sealant by ultraviolet light in a direction from the array substrate towards the color filter substrate.

13. A display panel, comprising the color filter substrate according to claim 1.

14. The display panel according to claim 13, wherein the main structure comprises:
a substrate, and
a pattern of a color filter layer and a pattern of a black matrix layer both arranged on the substrate,
wherein the pattern of the catalyst film layer is arranged at a region on the pattern of the black matrix layer where a sealant is located.

15. The display panel according to claim 14, wherein the pattern of the catalyst film layer comprises a light-conversion material capable of converting the ultraviolet light to infrared light.

16. The display panel according to claim 15, wherein the light-conversion material is a semiconductor light-conversion material or quantum dots.

17. The display panel according to claim 16, wherein the semiconductor light-conversion material comprises Nd³⁺ and Yb³⁺ doped lanthanum oxyhalide, and the quantum dots are CdSn or CdS.

18. A display device, comprising the display panel according to claim 13.
